(19) United States
(12) Patent Application Publication
(10) Pub. No.: US 2014/0306085 A1
(43) Pub. Date: Oct. 16, 2014

(54) LIGHT FIXTURE PENDANT HANGER

(71) Applicant: Kimber J. Clark, Jesup, GA (US)

(72) Inventor: Kimber J. Clark, Jesup, GA (US)

(21) Appl. No.: 14/286,337

(22) Filed: May 23, 2014

Related U.S. Application Data
(60) Provisional application No. 61/809,164, filed on Apr. 5, 2013.

(51) Int. Cl. F21S 8/06

(52) U.S. Cl. CPC F21S 8/063
USPC 248/544

(57) ABSTRACT

A light fixture pendant hanger safely hangs pendant mount light fixtures from conduit or other overhead tubing. The light fixture hanger includes two opposing J-hooks that can be turned 90 degrees to allow the conduit to be disposed between and under the J-hooks. The J-hooks can then be turned back 90 degrees, in opposing directions, and the fixture hanger lowered onto the conduit. With the J-hooks in opposing directions, the light fixture cannot be accidently bumped or jarred loose and fall.

### CROSS-REFERENCE TO RELATED APPLICATION

This application claims the benefit of priority of U.S. provisional application No. 61/809,164, filed Apr. 5, 2013, the contents of which are herein incorporated by reference.

### BACKGROUND OF THE INVENTION

The present invention relates to light fixture accessories and, more particularly, to a light fixture pendant hanger that safely hangs pendant mount light fixtures from conduit.

When hanging pendant mount light fixtures from pipes or conduits, if the light fixtures are not properly secured, they can be jarred loose and fall, potentially resulting in injury to people or objects under the light fixtures.

To overcome this problem, people often resort to safety chain, wire or cable to help secure the light fixtures. This, however, results in additional time and cost in the installation of the light fixtures.

As can be seen, there is a need for a device for conveniently hanging pendant mount light fixtures.

### SUMMARY OF THE INVENTION

In one aspect of the present invention, a hanging device comprises a conduit coupling having a first end for joining to a member to be hung and a second end; and first and second hooks extending from the second end of the conduit coupling, wherein the first and second hooks form a J-shape having opening disposed in opposite directions, and the first and second hooks pivot at least 90 degrees to permit the first and second hooks to be disposed substantially parallel to each other.

In another aspect of the present invention, a light fixture pendant hanger comprises a conduit coupling having a threaded first end, for joining to a conduit of a light fixture, and a second end; a chase nipple disposed into the second end of the conduit coupling; and first and second hooks extending from the second end of the conduit coupling, wherein the first and second hooks form a J-shape having opening disposed in opposite directions, and the first and second hooks pivot at least 90 degrees to permit the first and second hooks to be disposed substantially parallel to each other.

These and other features, aspects and advantages of the present invention will become better understood with reference to the following drawings, description and claims.

### BRIEF DESCRIPTION OF THE DRAWINGS

FIG. 1 is a perspective view of a light fixture hanger according to an exemplary embodiment of the present invention;

FIG. 2 is a cross-sectional view taken along line 2-2 of FIG. 1;

FIG. 3 is an exploded perspective view of the light fixture hanger of FIG. 1; and

FIG. 4 is a perspective view of a light fixture hanger, operable to attach to a square tubing, according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a light fixture pendant hanger that safely hangs pendant mount light fixtures from conduit or other overhead tubing. The light fixture hanger includes two opposing J-hooks that can be turned 90 degrees to allow the conduit to be disposed between and under the J-hooks. The J-hooks can then be turned back 90 degrees, in opposing directions, and the fixture hanger lowered onto the conduit. With the J-hooks in opposing directions, the light fixture cannot be accidently bumped or jarred loose and fall.

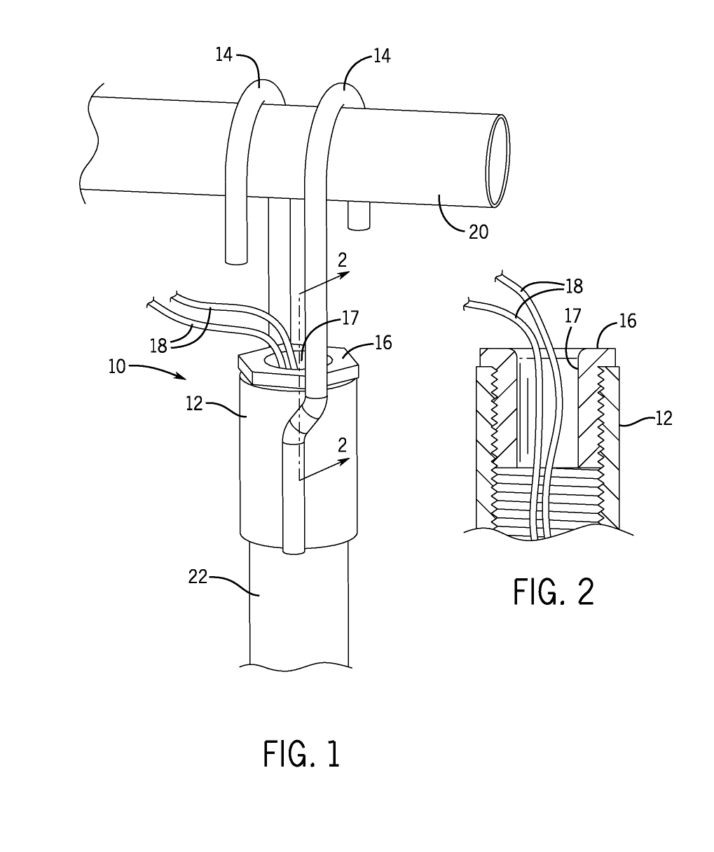

Referring now to FIGS. 1 through 3, a light fixture hanger 10 can include a conduit coupling 12 to receive conduit 22 from a light fixture (not shown). Typically, the conduit 22 can include male threads that thread into female threads formed in the conduit coupling 12, as shown in FIG. 2. However, other methods for coupling the conduit 22 to the conduit coupling 12 are contemplated within the scope of the present invention.

A chase nipple 16 can attach to the conduit coupling 12 opposite to the side where the conduit 22 connects to the conduit coupling 12. Typically the chase nipple 16 has male threads that thread into female threads formed in the conduit coupling 12. Similar to the conduit 22, other methods for coupling the chase nipple 16 to the conduit coupling 12 are contemplated within the scope of the present invention. The chase nipple 16 can eliminate wire abrasion between wires 18 passing through the conduit 22 and out of an opening 17 formed in the chase nipple 16. In some embodiments, a cord grip, or other such device, can be disposed on the conduit coupling 12 to secure the wires 18 and prevent abrasion of the wires 18. The wires 18 can extend from the lamp fixture (not shown), through the conduit 22, the conduit coupling 12 and the chase nipple 16 to connect to a power supply (not shown).

Hooks 14 can extend from the conduit coupling 12 in a direction away from a direction in which the conduit 22 extends. Typically, two hooks 14 extend from the conduit coupling 12 from opposite sides thereof. The hooks 14 are disposed to hook in opposite directions, as shown in FIG. 1, for example. In other words, an open side of one of the hooks 14 would open toward one side of the conduit coupling 12 and the open side of the other one of the hooks 14 would open toward an opposite side of the conduit coupling 12.

The hooks 14 can be designed to turn about 90 degrees, allowing a hanging conduit 20 to be disposed between the hooks 14 and below a terminus of each of the hooks 14. When the hooks 14 are turned back to their opposing position (as shown in FIG. 1), the hooks 14 can align to provide a channel into which the hanging conduit 20 can rest. Because the hooks 14 are in opposing directions, the light fixture supported by the hanger 10 of the present invention cannot be knocked off the hanging conduit 20.

If a user desires to remove the light fixture, they can simply raise the hanger so that the hanging conduit 20 is below the terminus of each of the hooks 14, turn the hooks 90 degrees, and lower the light fixture away from the hanging conduit.

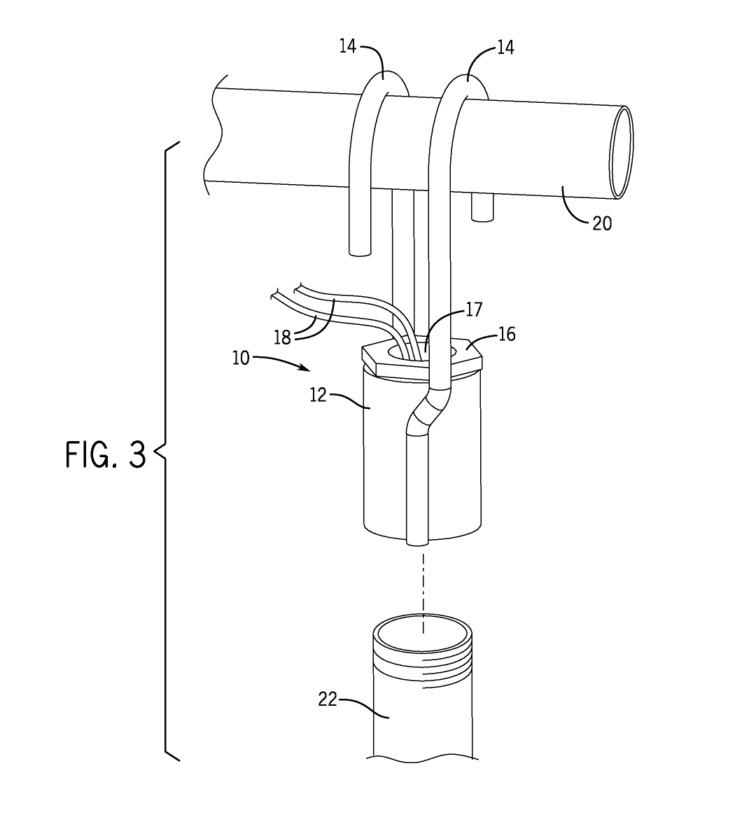

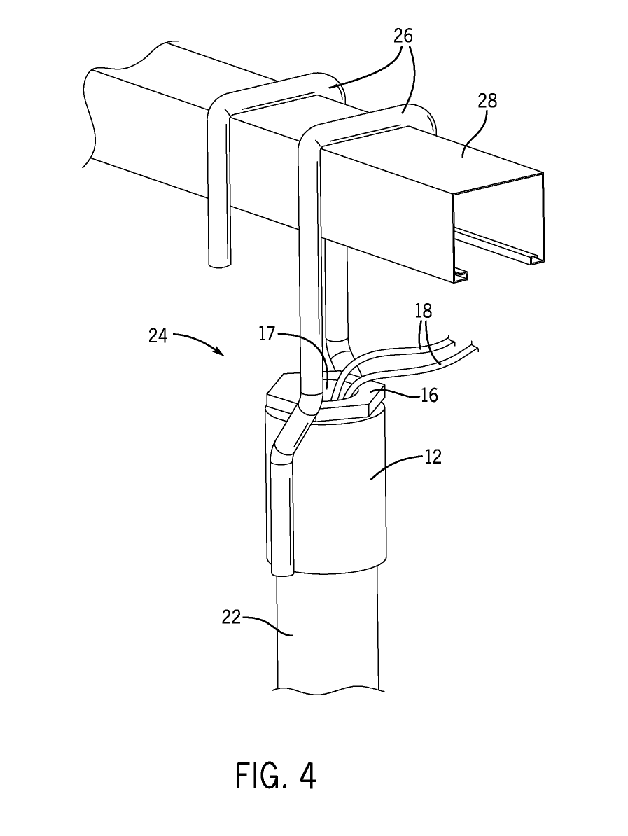

The hooks 14 are shown in FIGS. 1 and 3 as J-hooks, having a rounded inside surface for hanging the light fixture on a round conduit (such as hanging conduit 20, as shown in the Figures). However, in some embodiments, as shown in FIG. 4, for example, the hooks 14 can be modified as angular J-hooks 26 that can match the size and shape of a square strut channel 28. This hanger 24 can be similar to the hanger of FIGS. 1-3, except for the shape of the hook 14. While FIGS. 1 through 4 show two distinct shapes for the hooks 14, the hooks 14 can take any geometric or non-geometric shape, provided that a hanging conduit can be secured on the hooks 14 when they are disposed in opposing directions, as discussed above.

While the above refers to a hanger for hanging a light fixture, the hanger of the present invention may be used for supporting any piece of material or equipment that is required to be pendant mount, level and provide a level of safety due to bumping or jarring.

It should be understood, of course, that the foregoing relates to exemplary embodiments of the invention and that modifications may be made without departing from the spirit and scope of the invention as set forth in the following claims.

What is claimed is:

1. A hanging device comprising:
a conduit coupling having a first end for joining to a member to be hung and a second end; and
first and second hooks extending from the second end of the conduit coupling, wherein
the first and second hooks form a J-shape having opening disposed in opposite directions, and p1 the first and second hooks pivot at least 90 degrees to permit the first and second hooks to be disposed substantially parallel to each other.

2. The hanging device of claim 1, wherein the member to be hung is a conduit supporting a light fixture.

3. The hanging device of claim 1, wherein the first end of the conduit coupling includes threads for attaching the member to be hung.

4. The hanging device of claim 1, further comprising a chase nipple disposed into the second end of the conduit coupling.

5. The hanging device of claim 4, wherein the second end of the conduit coupling includes threads to mate with threads on the chase nipple.

6. The hanging device of claim 1, wherein the first and second hooks are shaped in a rounded J-shape, where the rounded J-shape receives a hanging conduit therewithin.

7. The hanging device of claim 1, wherein the first and second hooks are shaped in a squared J-shape, where the squared J-shape receives a square strut channel therewithin.

8. A light fixture pendant hanger comprising:
a conduit coupling having a threaded first end, for joining to a conduit of a light fixture, and a second end;
a chase nipple disposed into the second end of the conduit coupling; and
first and second hooks extending from the second end of the conduit coupling, wherein
the first and second hooks form a J-shape having opening disposed in opposite directions, and
the first and second hooks pivot at least 90 degrees to permit the first and second hooks to be disposed substantially parallel to each other.

9. The hanging device of claim 9, wherein the first and second hooks are shaped in a rounded J-shape, where the rounded J-shape receives a hanging conduit therewithin.

10. The hanging device of claim 8, wherein the first and second hooks are shaped in a squared J-shape, where the squared J-shape receives a square strut channel therewithin.
